(19) United States
(12) Patent Application Publication
(10) Pub. No.: US 2026/0089629 A1
(43) Pub. Date: Mar. 26, 2026

(54) TIME TO NEXT BURST INDICATIONS WITHIN A NETWORK

(71) Applicant: QUALCOMM Incorporated, San Diego, CA (US)

(72) Inventors: Hyun Yong LEE, San Diego, CA (US); Prasada Veera Reddy KADIRI, San Diego, CA (US); Mickaël MONDET, Louannec (FR); Diana MAAMARI, San Diego, CA (US); Liangping MA, San Diego, CA (US); Sebastian SPEICHER, Wallisellen (CH); Linhai HE, San Diego, CA (US)

(21) Appl. No.: 19/340,373

(22) Filed: Sep. 25, 2025

Related U.S. Application Data
(60) Provisional application No. 63/699,610, filed on Sep. 26, 2024.

(51) Int. Cl. H04W 52/02; H04W 72/0446; H04W 76/12

(52) U.S. Cl. CPC H04W 52/0216; H04W 72/0446; H04W 76/12

(57) ABSTRACT

Various aspects of the present disclosure generally relate to wireless communication. In some aspects, a data source may encode a time to next burst (TTNB) field in a header of a protocol data unit (PDU) within a PDU set of a first PDU burst. The data source may be an application server (AS) encoding the TTNB field or a user plane function (UPF) encoding the TTNB field. The data source may transmit, to a network element, the PDU set of the first PDU burst. The network element may be the UPF receiving from the AS or a radio access network receiving from the UPF. Numerous other aspects are described.

### CROSS-REFERENCE TO RELATED APPLICATION

This patent application claims priority to U.S. Provisional Patent Application No. 63/699,610, filed on Sep. 26, 2024, entitled “TIME TO NEXT BURST INDICATIONS WITHIN A NETWORK,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods associated with transmitting, receiving, and using time to next burst indications.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a data source. The method may include encoding a time to next burst (TTNB) field in a header of a protocol data unit (PDU) within a PDU set of a first PDU burst. The method may include transmitting, to a network element, the PDU set of the first PDU burst.

Some aspects described herein relate to a method of wireless communication performed by a network element. The method may include receiving, from a data source, a PDU set of a first PDU burst. The method may include decoding a TTNB field in a header of a PDU within the PDU set of the first PDU burst.

Some aspects described herein relate to a data source. The data source may include a processing system. The processing system may include one or more processors and one or more code-storing memories coupled with the one or more processors. The processing system may be configured to cause the data source to encode a TTNB field in a header of a PDU within a PDU set of a first PDU burst. The processing system may be configured to cause the data source to transmit, to a network element, the PDU set of the first PDU burst.

Some aspects described herein relate to a network element. The network element may include a processing system. The processing system may include one or more processors and one or more code-storing memories coupled with the one or more processors. The processing system may be configured to cause the network element to receive, from a data source, a PDU set of a first PDU burst. The processing system may be configured to cause the network element to decode a TTNB field in a header of a PDU within the PDU set of the first PDU burst.

Some aspects described herein relate to a non-transitory computer-readable medium that stores a set of instructions for wireless communication by a data source. The set of instructions, when executed by one or more processors of the data source, may cause the data source to encode a TTNB field in a header of a PDU within a PDU set of a first PDU burst. The set of instructions, when executed by one or more processors of the data source, may cause the data source to transmit, to a network element, the PDU set of the first PDU burst.

Some aspects described herein relate to a non-transitory computer-readable medium that stores a set of instructions for wireless communication by a network element. The set of instructions, when executed by one or more processors of the network element, may cause the network element to receive, from a data source, a PDU set of a first PDU burst. The set of instructions, when executed by one or more processors of the network element, may cause the network element to decode a TTNB field in a header of a PDU within the PDU set of the first PDU burst.

Some aspects described herein relate to an apparatus for wireless communication. The apparatus may include means for encoding a TTNB field in a header of a PDU within a PDU set of a first PDU burst. The apparatus may include means for transmitting, to a network element, the PDU set of the first PDU burst.

Some aspects described herein relate to an apparatus for wireless communication. The apparatus may include means for receiving, from a data source, a PDU set of a first PDU burst. The apparatus may include means for decoding a TTNB field in a header of a PDU within the PDU set of the first PDU burst.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram of an example of a core network configured to provide network slicing.

FIG. 4 is a diagram illustrating an example of protocol data unit (PDU) sets and PDU bursts.

FIG. 5 is a diagram illustrating an example associated with time to next burst (TTNB) signaling from an application server to a radio access network via a user plane function.

FIGS. 6A, 6B, 6C, 6D, and 6E are diagrams illustrating examples associated with TTNB categories.

FIG. 7 is a diagram illustrating an example process associated with transmitting TTNB indications.

FIG. 8 is a diagram illustrating an example process associated with receiving TTNB indication.

FIGS. 9 and 10 are diagrams of example apparatuses for wireless communication.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Some types of traffic, such as extended reality (XR) traffic, are periodic. For example, periodic traffic may be characterized by bursts of packets that are queued according to an approximate periodicity. Therefore, in a wireless network (e.g., a 5G network), transmissions to a user equipment (UE) may similarly be periodic because data arrives at a wireless network for transmission according to the approximate periodicity.

Various aspects relate generally to an application server providing a time to next burst (TTNB) indication to a user plane function (UPF). Some aspects more specifically relate to providing an absolute time associated with a next protocol data unit (PDU) burst. Alternatively, some aspects more specifically relate to providing a relative time associated with a next PDU burst. In some aspects, the application server may provide the TTNB indication in a real time protocol (RTP) header extension (RTP-HE). Additionally, or alternatively, various aspects relate generally to a UPF providing a TTNB indication to a radio access network (RAN). Some aspects more specifically relate to providing an absolute time associated with a next PDU burst. Alternatively, some aspects more specifically relate to providing a relative time associated with a next PDU burst. In some aspects, the UPF may provide the TTNB indication in a general packet radio service (GPRS) tunnelling protocol (GTP) header.

Particular aspects of the subject matter described in this disclosure can be implemented to realize one or more of the following potential advantages. In some examples, the described techniques can be used to provide TTNB information from the application server to the RAN via the UPF. Accordingly, the RAN may schedule a UE (that is receiving the PDU bursts) to conserve power (e.g., when the TTNB information indicates longer times between PDU bursts) and/or to reduce latency (e.g., when the TTNB information indicates shorter times between PDU bursts). In some aspects, because the application server initiates traffic to the UE, the application server may adjust the TTNB information based on buffer status of the UE (e.g., reducing overhead when the UE buffers more PDU sets). Additionally, or alternatively, the UPF may adjust the TTNB information received from the application server in order to increase TTNB accuracy for the RAN.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, XR and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

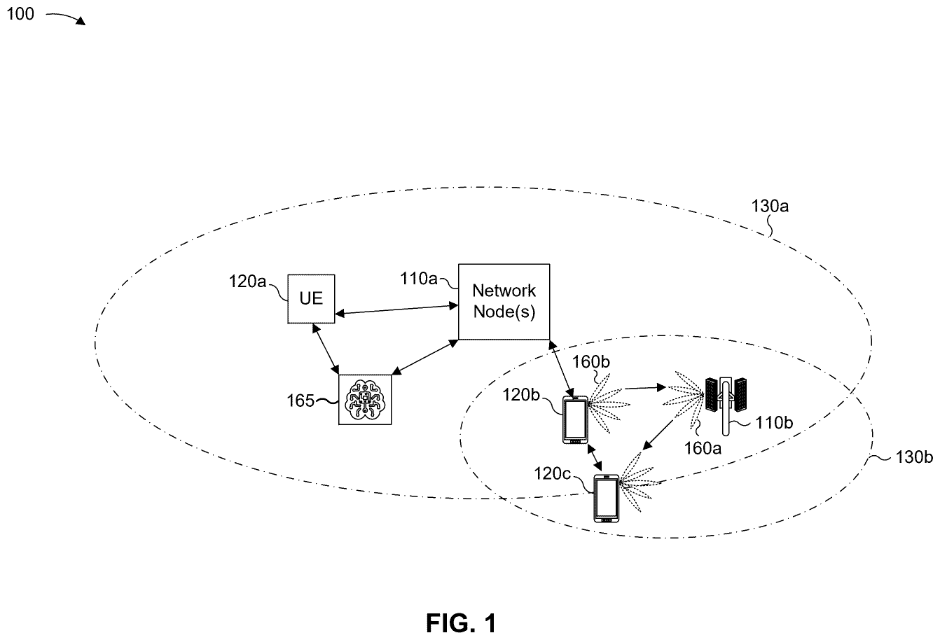

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHZ), FR3 (7.125 GHz through 24.25 GHz), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a RAN. In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

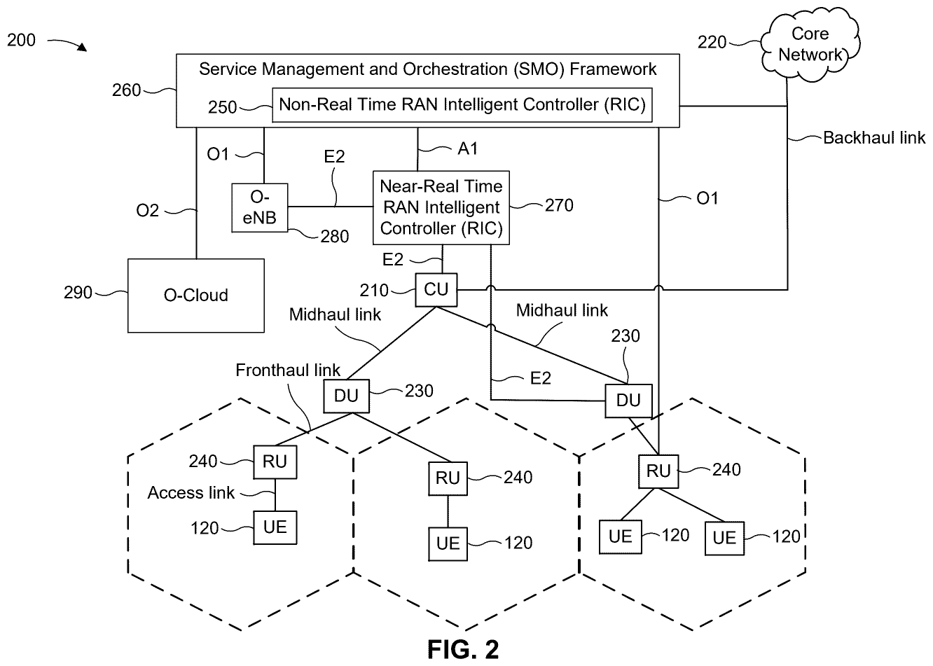

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUS). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUS 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

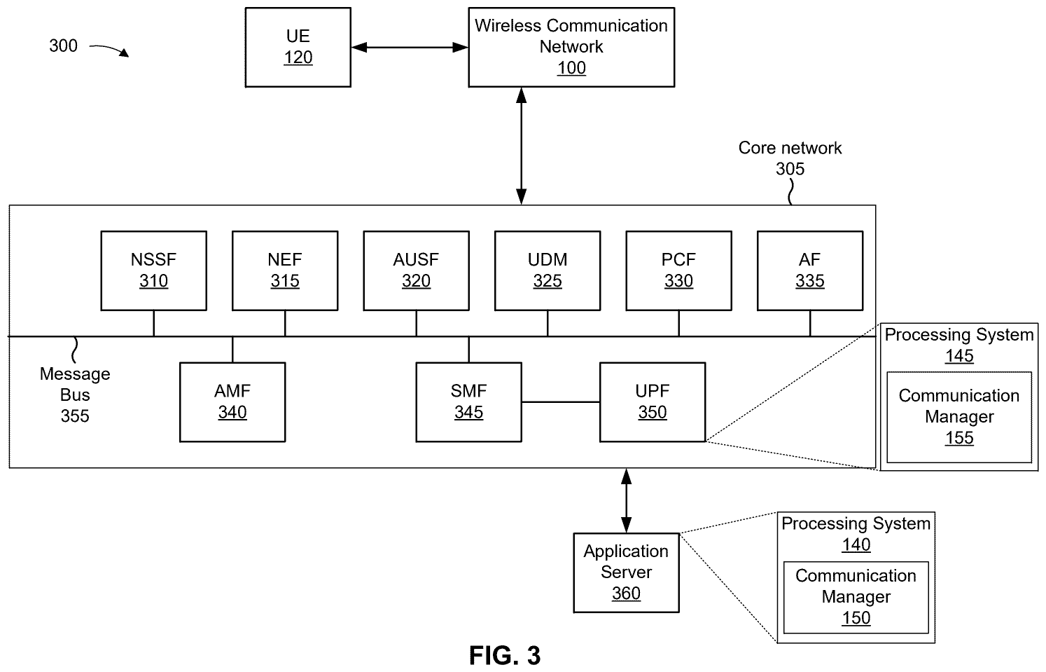

FIG. 3 is a diagram of an example 300 of a core network 305 configured to provide network slicing. As shown in FIG. 3, example 300 may include a UE 120, a wireless communication network 100, a core network 305, and an application server 360. Devices and/or networks of example 300 may interconnect via wired connections, wireless connections, or a combination thereof.

The wireless communication network 100 may support, for example, a cellular RAT. The network 100 may include one or more network nodes, such as base stations (e.g., base transceiver stations, radio base stations, node Bs, eNodeBs (eNBs), gNodeBs (gNBs), base station subsystems, cellular sites, cellular towers, access points, TRPs, radio access nodes, macrocell base stations, microcell base stations, picocell base stations, femtocell base stations, or similar types of devices) and other network nodes that can support wireless communication for the UE 120. The network 100 may transfer traffic between the UE 120 (e.g., using a cellular RAT), one or more network nodes (e.g., using a wireless interface or a backhaul interface, such as a wired backhaul interface), and/or the core network 305. The wireless communication network 100 may provide one or more cells that cover geographic areas.

In some aspects, the wireless communication network 100 may perform scheduling and/or resource management for the UE 120 covered by the network 100 (e.g., the UE 120 covered by a cell provided by the wireless communication network 100). In some aspects, the wireless communication network 100 may be controlled or coordinated by a network controller (e.g., network controller 130 of FIG. 1), which may perform load balancing and/or network-level configuration, among other examples. As described above in connection with FIG. 1, the network controller may communicate with the network 100 via a wireless or wireline backhaul. In some aspects, the network 100 may include a network controller, a self-organizing network (SON) module or component, or a similar module or component. Accordingly, the network 100 may perform network control, scheduling, and/or network management functions (e.g., for uplink, downlink, and/or sidelink communications of the UE 120 covered by the network 100).

In some aspects, the core network 305 may include an example functional architecture in which systems and/or methods described herein may be implemented. For example, the core network 305 may include an example architecture of a fifth generation (5G) next generation (NG) core network included in a 5G wireless telecommunications system. Although the example architecture of the core network 305 shown in FIG. 3 may be an example of a service-based architecture, in some aspects, the core network 305 may be implemented as a reference-point architecture and/or a 4G core network, among other examples.

As shown in FIG. 3, the core network 305 may include a number of functional elements. The functional elements may include, for example, a network slice selection function (NSSF) 310, a network exposure function (NEF) 315, an authentication server function (AUSF) 320, a unified data management (UDM) component 325, a policy control function (PCF) 330, an application function (AF) 335, an access and mobility management function (AMF) 340, a session management function (SMF) 345, and/or a UPF 350, among other examples. These functional elements may be communicatively connected via a message bus 355. Each of the functional elements shown in FIG. 3 may be implemented on one or more devices associated with a wireless telecommunications system. In some implementations, one or more of the functional elements may be implemented on physical devices, such as an access point, a base station, and/or a gateway, among other examples. In some implementations, one or more of the functional elements may be implemented on a computing device of a cloud computing environment.

The NSSF 310 may include one or more devices that select network slice instances for the UE 120. Network slicing is a network architecture model in which logically distinct network slices operate using common network infrastructure. For example, several network slices may operate as isolated end-to-end networks customized to satisfy different target service standards for different types of applications executed, at least in part, by the UE 120 and/or communications to and from the UE 120. Network slicing may efficiently provide communications for different types of services with different service standards.

The NSSF 310 may determine a set of network slice policies to be applied at the wireless communication network 100. For example, the NSSF 310 may apply one or more UE route selection policy (URSP) rules. In some aspects, the NSSF 310 may select a network slice based on a mapping of a data network name (DNN) field included in a route selection description (RSD) to the DNN field included in a traffic descriptor selected by the UE 120. By providing network slicing, the NSSF 310 allows an operator to deploy multiple substantially independent end-to-end networks potentially with the same infrastructure. In some implementations, each slice may be customized for different services.

The NEF 315 may include one or more devices that support exposure of capabilities and/or events in the wireless telecommunications system to help other entities in the wireless telecommunications system discover network services. The AUSF 320 may include one or more devices that act as an authentication server and support the process of authenticating the UE 120 in the wireless telecommunications system.

The UDM 325 may include one or more devices that store user data and profiles in the wireless telecommunications system. In some aspects, the UDM 325 may be used for fixed access and/or mobile access, among other examples, in the core network 305.

The PCF 330 may include one or more devices that provide a policy framework that incorporates network slicing, roaming, packet processing, and/or mobility management, among other examples. In some aspects, the PCF 330 may include one or more URSP rules used by the NSSF 310 to select network slice instances for the UE 120. In some aspects described herein, the PCF 330 may set a policy and charging control (PCC) rule that indicates support for TTNB indications. For example, the PCF 330 may determine to set the PCC rule for 5-tuple, specific data flows (e.g., XR traffic).

The AF 335 may include one or more devices that support application influence on traffic routing, access to the NEF 315, and/or policy control, among other examples. The AMF 340 may include one or more devices that act as a termination point for non-access stratum (NAS) signaling and/or mobility management, among other examples. In some aspects, the AMF may request the NSSF 310 to select network slice instances for the UE 120, e.g., at least partially in response to a request for data service from the UE 120.

The SMF 345 may include one or more devices that support the establishment, modification, and release of communication sessions in the wireless telecommunications system. For example, the SMF 345 may configure traffic steering policies at the UPF 350 and/or enforce user equipment Internet protocol (IP) address allocation and policies, among other examples. In some aspects, the SMF 345 may provision the network slice instances selected by the NSSF 310 for the UE 120. In some aspects described herein, the SMF 345 may request that the UPF 350 encode TTNB indications (e.g., according to a PCC rule, as described above, and/or a local operator policy).

The UPF 350 may include one or more devices that serve as an anchor point for intraRAT and/or interRAT mobility. In some aspects, the UPF 350 may apply rules to packets, such as rules pertaining to packet routing, traffic reporting, and/or handling user plane QoS, among other examples. In some aspects described herein, the UPF 350 may indicate, to the SMF 345, support for TTNB indications. For example, the UPF 350 may transmit, and the SMF 345 may receive, a message including a feature indication for TTNB marking (TTNBM) along with a feature indication for PDU set marking (PDUSM). As described above, the SMF 345 may request that the UPF 350 use TTNB indications (e.g., in response to the TTNBM feature indication). Additionally, or alternatively, the network 100 may request that the UPF 350 use TTNB indications (whether from the application server 360 or independently determined by the UPF 350).

The message bus 355 may be a logical and/or physical communication structure for communication among the functional elements. Accordingly, the message bus 355 may permit communication between two or more functional elements, whether logically (e.g., using one or more application programming interfaces (APIs), among other examples) and/or physically (e.g., using one or more wired and/or wireless connections).

The application server 360 may include a standalone server, a cloud system, or another type of computing device providing data to the UE 120 (via the core network 305 and the network 100) and/or receiving data from the UE 120 (via the network 100 and the core network 305). The application server 360 may be associated with an application executed by the UE 120.

In some aspects, the application server 360 may include a processing system 140 that includes a communication manager 150. As described in more detail elsewhere herein, the communication manager 150 may encode a TTNB field in a header of a PDU within a PDU set of a first PDU burst and may transmit (e.g., to the UPF 350) the PDU set of the first PDU burst. Additionally, or alternatively, the communication manager 150 may perform one or more other operations described herein. In some aspects, the processing system 140 (that includes the communication manager 150) may be included in the UPF 350, and the PDU set may be transmitted to the network 100.

In some aspects, the UPF 350 may include a processing system 145 that includes a communication manager 155. As described in more detail elsewhere herein, the communication manager 155 may receive (e.g., from the application server 360) a PDU set of a first PDU burst and may decode a TTNB field in a header of a PDU within the PDU set of the first PDU burst. Additionally, or alternatively, the communication manager 155 may perform one or more other operations described herein. In some aspects, the processing system 145 (that includes the communication manager 155) may be included in the network 100, and the PDU set may be received from the UPF 350.

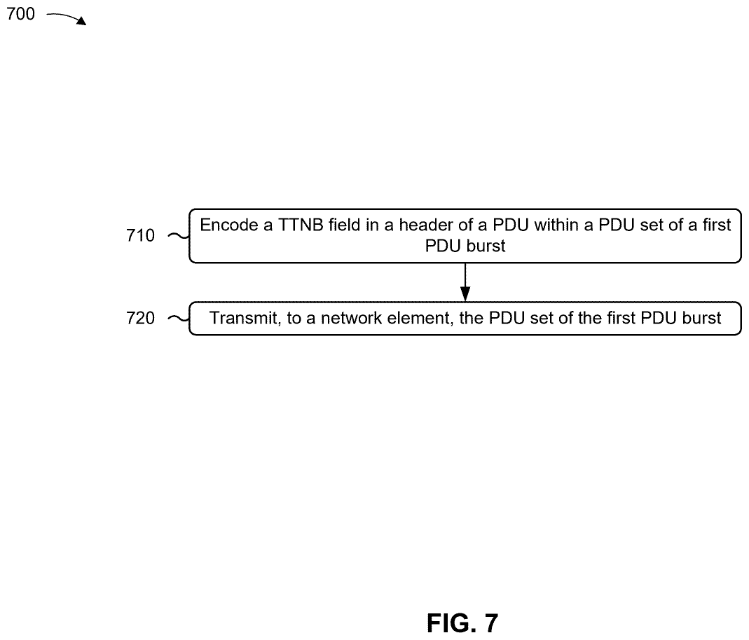

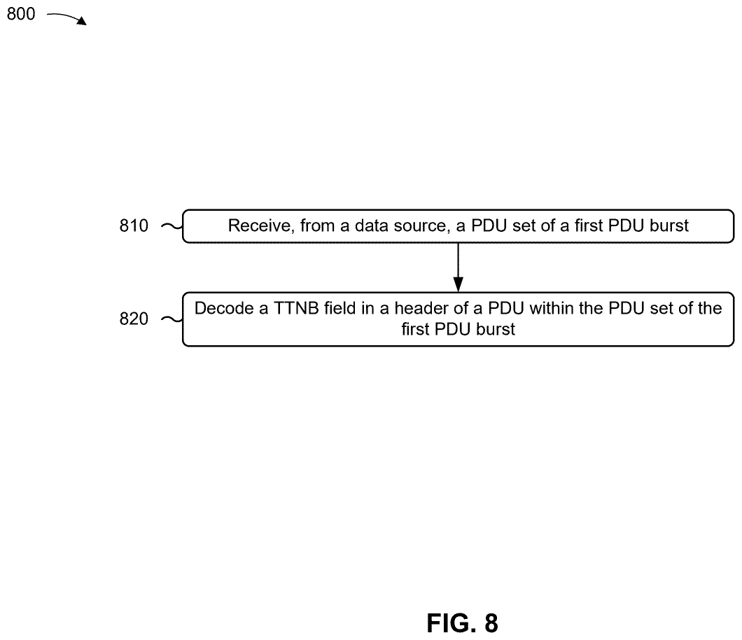

The network node 110, the application server 360, the processing system 140, the UPF 350, the processing system 145, or any other component(s) of FIGS. 1-3 may implement one or more techniques or perform one or more operations associated with transmitting, receiving, and using TTNB indications, as described in more detail elsewhere herein. For example, the network node 110, the application server 360, the processing system 140, the UPF 350, or the processing system 145 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of the UPF 350 may store data and program code (or instructions) for the UPF 350, such as user data. Memory of the application server 360 may store data and program code (or instructions) for the application server 360, such as application traffic. In some examples, the memory of the network node 110, the memory of the UPF 350, or the memory of the application server 360 may include a non-transitory computer-readable medium storing a set of instructions for wireless communication. For example, the set of instructions, when executed by one or more processors (for example, of the processing system 145 or the processing system 140) may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

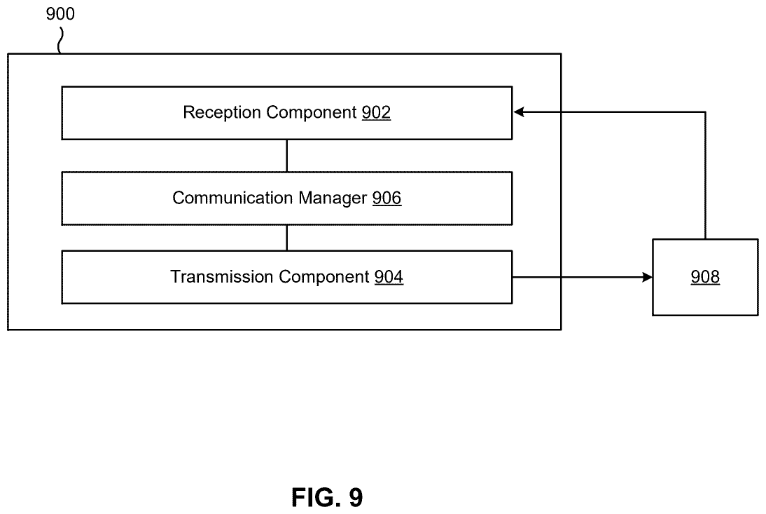

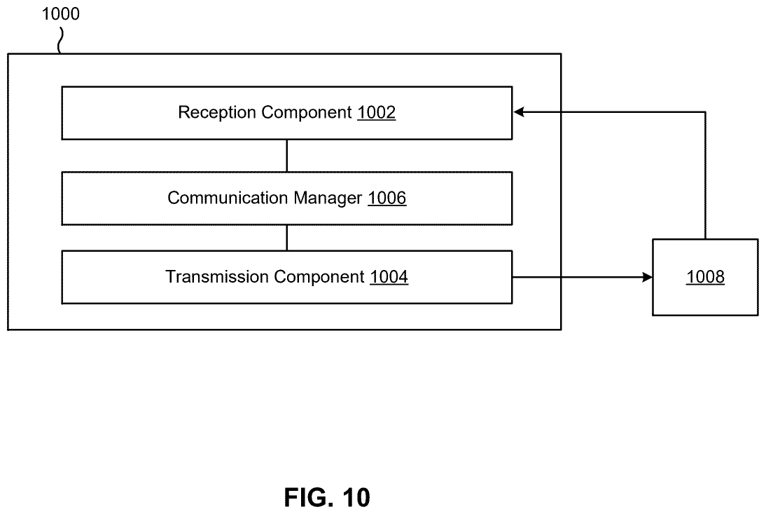

In some aspects, a data source (e.g., the application server 360, the UPF 350, and/or apparatus 900 of FIG. 9) may include means for encoding a TTNB field in a header of a PDU within a PDU set of a first PDU burst and/or means for transmitting, to a network element (e.g., the UPF 350, a component of the network 100, and/or apparatus 1000 of FIG. 10), the PDU set of the first PDU burst. In some aspects, the means for the data source to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

In some aspects, a network element (e.g., the UPF 350, a component of the network 100, and/or apparatus 1000 of FIG. 10) may include means for receiving, from a data source (e.g., the application server 360, the UPF 350, and/or apparatus 900 of FIG. 9), a PDU set of a first PDU burst and/or means for decoding a TTNB field in a header of a PDU within the PDU set of the first PDU burst. In some aspects, the means for the network element to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of example 300 may perform one or more functions described as being performed by another set of devices of example environment 300.

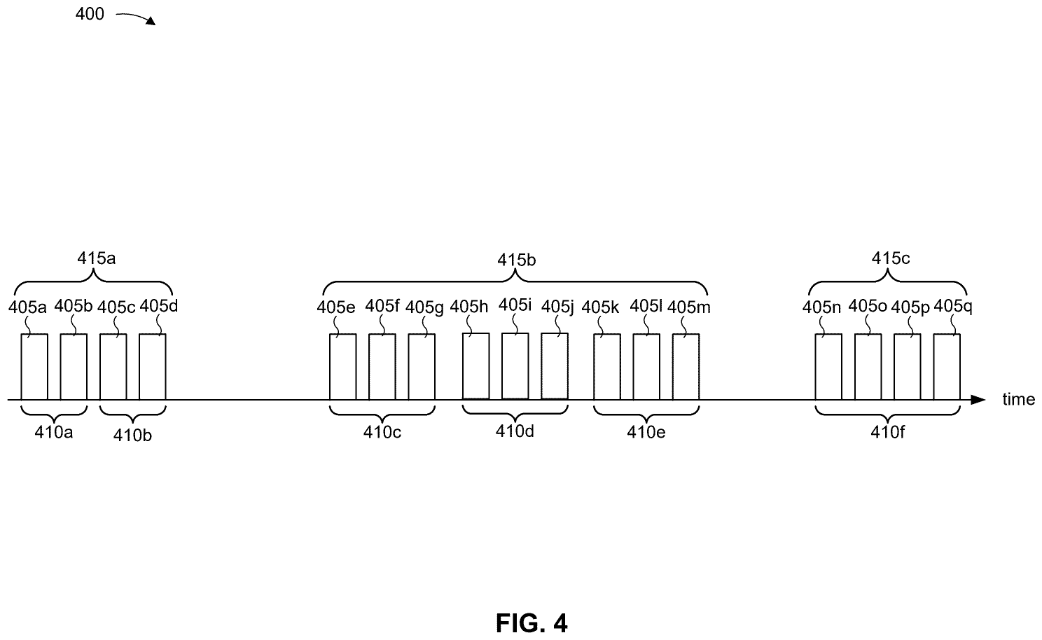

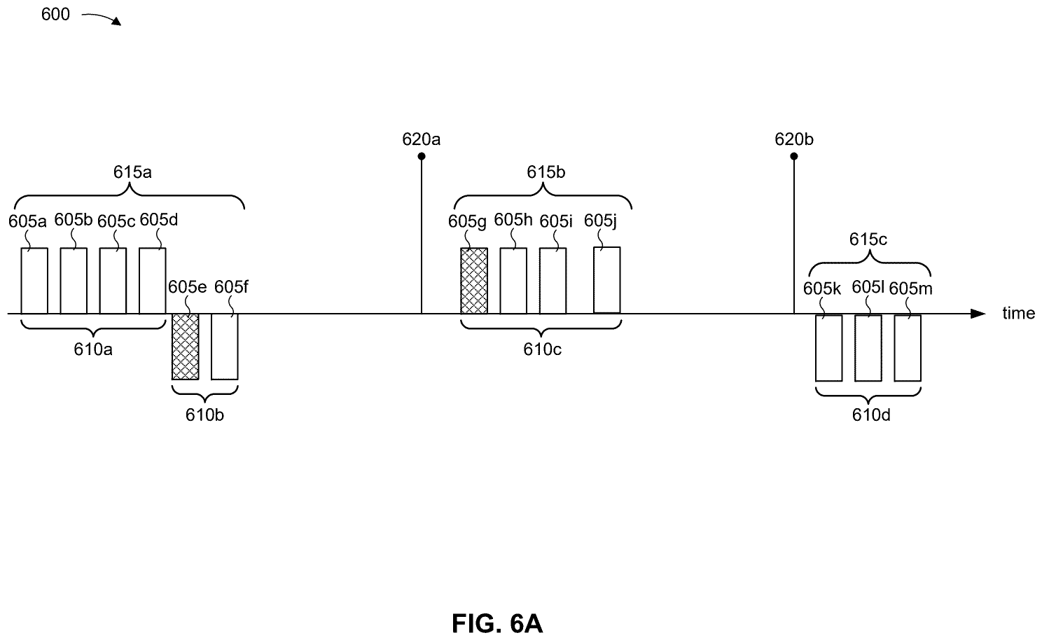

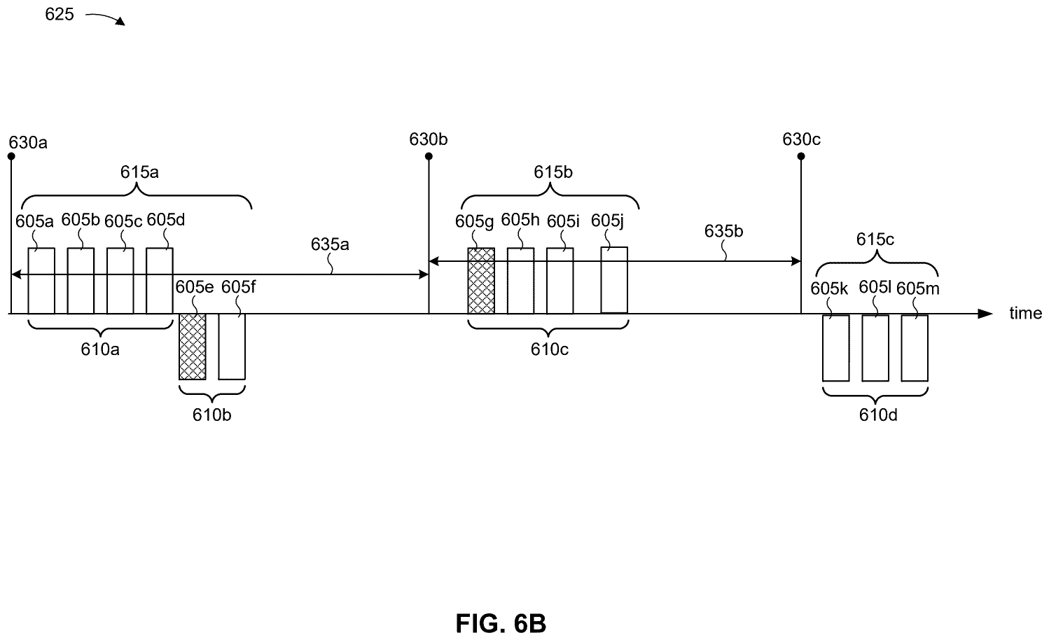

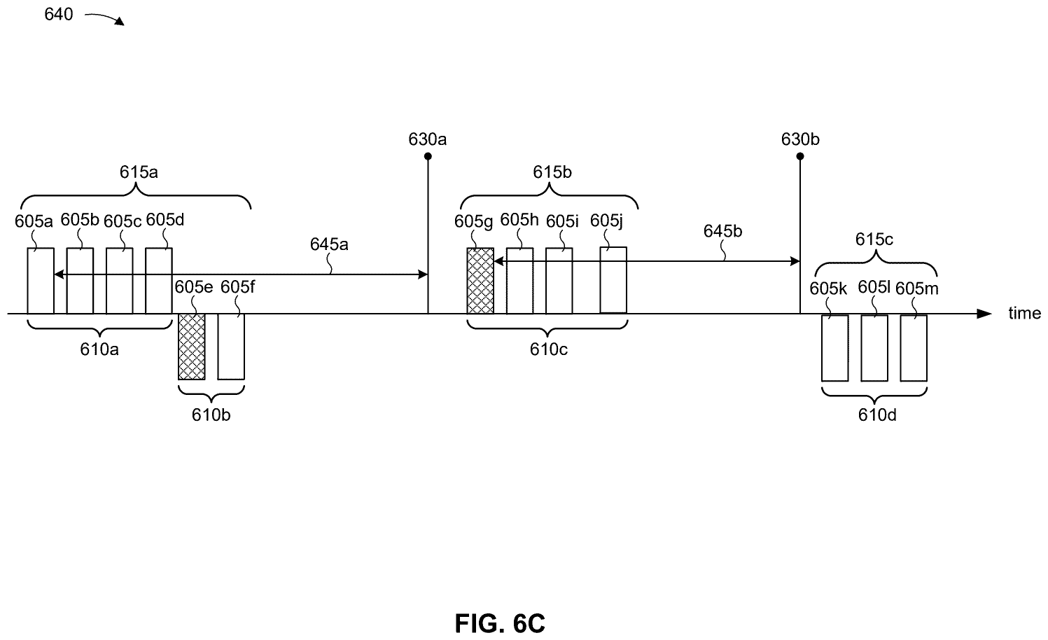

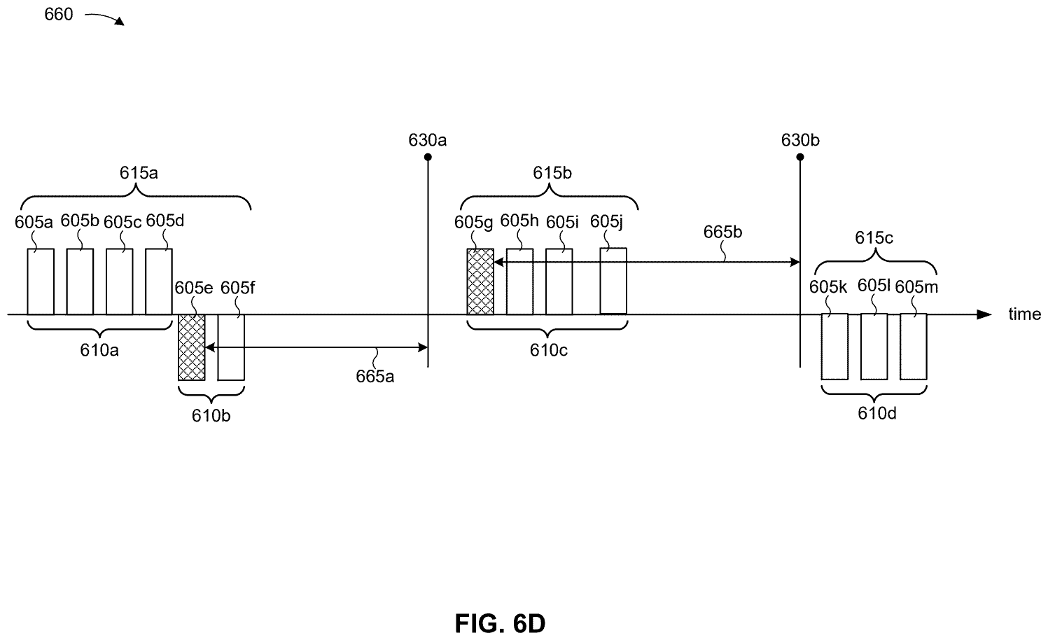

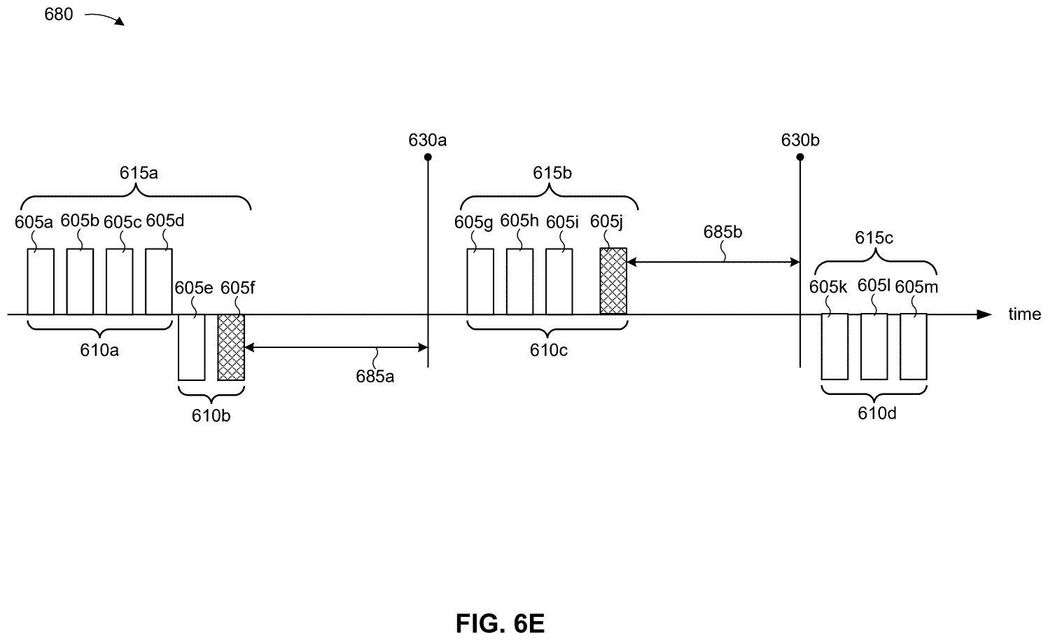

FIG. 4 is a diagram illustrating an example 400 of PDU sets and PDU bursts. As shown in FIG. 4. PDUs 405 may be received (e.g., by a UPF from an application server, by a RAN from a UPF, or by a UE from a RAN) over time. In the example 400, PDUs 405a and 405b are associated with a PDU set 410a (e.g., via a PDU set sequence number (PSSN) corresponding to the PDU set 410a) and PDUs 405c and 405d are associated with a PDU set 410b (e.g., via a PSSN corresponding to the PDU set 410b). In some aspects, the PDU sets 410a and 410b are included in a same PDU burst 415a. For example, the PDU sets 410a and 410b may be included in the same PDU burst 415a based at least in part on a minimum timing gap. The minimum timing gap may be defined in a standard (e.g., 3GPP specifications and/or another standard), may be indicated to the application server (e.g., by a component of a 5G system, such as a function in a core network), and/or may be indicated to the UPF (e.g., by the RAN). Accordingly, the application server (and/or the UPF) may determine PDU bursts according to the minimum timing gap. Grouping PDU sets that are close in time allows the application server (and/or the UPF) to estimate a TTNB across PDU sets (e.g., using data volume, flow dependencies, and/or the minimum timing gap, among other examples), as described in connection with FIGS. 6A-6E.

Additionally, or alternatively, the PDU sets 410a and 410b may be included in the same PDU burst 415a based at least in part on the PDU sets 410a and 410b being associated with a same video frame. A policy instructing that PDU sets associated with a same video frame should be grouped in a same PDU burst may be defined in a standard (e.g., 3GPP specifications and/or another standard), may be indicated to the application server (e.g., by a component of a 5G system, such as a function in a core network), and/or may be indicated to the UPF (e.g., by the RAN). Grouping PDU sets that are associated with a same video frame prevents latency between frames that would otherwise degrade performance at a UE.

As further shown in FIG. 4, a PDU burst may include more PDU sets, and a PDU set may include more PDUs. For example, PDUs 405e, 405f, and 405g are associated with a PDU set 410c (e.g., via a PSSN corresponding to the PDU set 410c), and PDUs 405h, 405i, and 405j are associated with a PDU set 410d (e.g., via a PSSN corresponding to the PDU set 410d), and PDUs 405k, 405l, and 405m are associated with a PDU set 410e (e.g., via a PSSN corresponding to the PDU set 410e). Additionally, the PDU sets 410c. 410d, and 410e may be included in a same PDU burst 415b. In another example, a PDU burst may include a single PDU set. For example, PDUs 405n, 405o, 405p, and 405q are associated with a PDU set 410f (e.g., via a PSSN corresponding to the PDU set 410f), which is the only PDU set included in PDU burst 415c.

As indicated above, FIG. 4 is provided as an example. Other examples may differ from what is described with respect to FIG. 4. For example, a PDU set may include fewer than three PDUs or more than four PDUs. Additionally, or alternatively, a PDU burst may include more than three PDU sets.

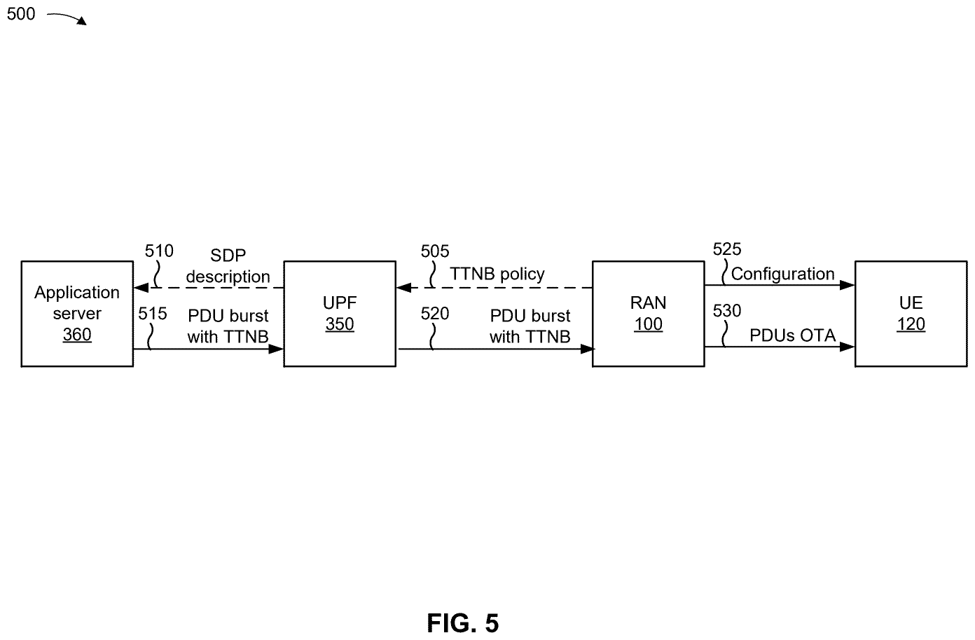

FIG. 5 is a diagram illustrating an example 500 associated with TTNB signaling from an application server to a RAN via a UPF. As shown in FIG. 5, the example 500 includes an application server 360 that communicates with a UPF 350 (e.g., over an N6 interface). The example 500 further includes the UPF 350 communicating with a RAN 100 (e.g., over an N3 interface). The RAN 100 may communicate OTA with a UE 120 (e.g., using a dedicated radio bearer (DRB)).

As shown by reference number 505, the RAN 100 may transmit, and the UPF 350 may receive, a policy associated with TTNB indications. For example, as described in connection with FIG. 4, the policy may include a minimum timing gap for PDU sets and/or an instruction to group PDU sets belonging to a same video frame in a same PDU set. Additionally, or alternatively, as shown by reference number 510, the UPF 350 may transmit, and the application server 360 may receive, a session description protocol (SDP) message. For example, the SDP message may indicate that the UPF 350 supports a TTNB field (e.g., in an RTP-HE). The SDP message may additionally indicate the policy associated with TTNB indications.

Accordingly, the application server 360 may estimate a TTNB (e.g., using traffic flows and/or a frame packet generation time, among other examples). The application server 360 may encode the TTNB within at least one PDU of (a PDU set in) a PDU burst. The TTNB may indicate a time to a next PDU burst, with a particular granularity, as described in connection with FIGS. 6A-6E. As shown by reference number 515, the application server 360 may transmit, and the UPF 350 may receive, one or more PDU sets within the PDU burst. The TTNB may be encoded in a field of a header of a PDU within the PDU burst. For example, the field may be included in an RTP-HE.

In some aspects, the application server 360 may encode the TTNB field in a last PDU of the PDU burst. As a result, accuracy of the TTNB may be increased because the application server 360 may use more time and information to estimate the TTNB. Additionally, or alternatively, the application server 360 may encode the TTNB field in an initial PDU of the PDU burst. As a result, the UPF 350 may estimate timing of a next PDU burst without storing an arrival time associated with the initial PDU (e.g., as described in connection with FIG. 6C). Additionally, or alternatively, the application server 360 may encode the TTNB field in any PDU of the PDU burst (or even more than one PDU of the PDU burst). As a result, flexibility for the application server 360 is improved. In some aspects, the application server 360 may adjust TTNB indications based at least in part on buffer status (e.g., at the UE 120) and/or latency. For example, the application server 360 may include TTNB fields every other frame when the UE 120 buffers two frames at a time.

The UPF 350 may thus decode the TTNB field in the RTP-HE to determine the TTNB. In some aspects, the application server 360 may indicate the TTNB within each PDU burst in order to improve accuracy (for the UPF 350 and, in turn, the RAN 100). Alternatively, the application server 360 may refrain from encoding a TTNB field, when a value of the TTNB is unchanged, in order to reduce overhead. Accordingly, the UPF 350 may determine that the value of the TTNB is unchanged based at least in part on a lack of a TTNB field in a PDU set.

Additionally, or alternatively, the UPF 350 may estimate a TTNB (e.g., using end of PDU set indications from the application server 360, traffic patterns indicated by a time sensitive communications (TSC) assistance container (TSCAC) and/or TSC assistance information (TSCAI), among other examples). Additionally, or alternatively, the UPF 350 may apply an AI/ML model (or a plurality of AI/ML models) to estimate the TTNB. In some aspects, the UPF 350 may drop TTNB indications from the application server 360 (and optionally generate encode new TTNB fields) in response to accuracy of the TTNB indications (as estimated by the UPF 350) failing to satisfy an accuracy threshold. Alternatively, the UPF 350 may adjust TTNB indications from the application server 360 (e.g., to compensate for jitter on the N6 interface and/or to compensate for clock drift associated with the application server 360, the UPF 350, and/or the RAN 100).

As shown by reference number 520, the application server 360 may transmit, and the UPF 350 may receive, the PDU set(s) within the PDU burst. The TTNB may be encoded in a field of a header of a PDU within the PDU burst. For example, the field may be included in a GTP header (e.g., a GTP-U header). The field may be included in a PDU set information container of an extension header for the GTP-U header.

Within the RAN 100, a CU (e.g., a user plane portion of the CU, also referred to as a CU-UP) may transmit information from the TTNB field to a DU. For example, the CU may transmit the information over an F1 interface (e.g., an F1-U interface) to the DU. The CU may encode the information in a GTP header (e.g., a GTP-U header). The field may be included in a PDU set information container of an extension header for the GTP-U header.

In some aspects, a source node within the RAN 100 may transmit information from the TTNB field to a target node. For example, the source node may transmit the information over an Xn-U interface to the target node for a handover operation. The source node may encode the information in a GTP header (e.g., a GTP-U header). The field may be included in a PDU set information container of an extension header for the GTP-U header.

The RAN 100 (e.g., the DU within the RAN 100) may use information from the TTNB field to schedule the UE 120. For example, as shown by reference number 525, the RAN 100 (e.g., the DU within the RAN 100) may transmit a configuration (e.g., a discontinuous reception (DRX) configuration) to the UE 120, where the RAN 100 determines the configuration (e.g., a periodicity, an ON duration, and/or a sleep duration) using information from the TTNB field. Additionally, or alternatively, the RAN 100 (e.g., the DU within the RAN 100) may transmit a search space set group (SSSG) switching command based at least in part on information from the TTNB field (e.g., to align monitoring of the UE 120 with arrival of a next PDU burst). In some aspects, the RAN 100 (e.g., the DU within the RAN 100) may transmit a go-to-sleep signal based at least in part on information from the TTNB field (e.g., to align power saving of the UE 120 with a gap before a next PDU burst). Alternatively, the RAN 100 (e.g., the DU within the RAN 100) may transmit a dummy message based at least in part on information from the TTNB field (e.g., to prevent the UE 120 going to sleep because a next PDU burst is imminent). As shown by reference number 530, the RAN 100 (e.g., the DU within the RAN 100) may transmit, and the UE 120 may receive, the PDU set(s) within the PDU burst.

The application server 360 may additionally indicate a predicted size for a next PDU burst (e.g., in a same field as the TTNB or another field in the RTP-HE). Accordingly, the UPF 350 may indicate the predicted size for the next PDU burst (e.g., in a same field as the TTNB or another field in the GTP-U header). Therefore, the RAN 100 (e.g., the DU within the RAN 100) may use the predicted size to configure the UE 120 accordingly (e.g., with additional downlink resources to accommodate a larger PDU burst or with fewer downlink resources for a smaller PDU burst to conserve power). Additionally, or alternatively, the application server 360 may indicate a PDU set identifier and/or a PSSN associated with the next PDU burst.

Accordingly, the UPF 350 may indicate the PDU set identifier and/or the PSSN associated with the next PDU burst.

As indicated above, FIG. 5 is provided as an example. Other examples may differ from what is described with respect to FIG. 5.

FIGS. 6A, 6B, 6C, 6D, and 6E are diagrams illustrating examples 600, 625, 640, 660, and 680, respectively, associated with TTNB categories. FIGS. 6A-6E all depict timings associated with different PDU sets across multiple PDU bursts.

As shown in FIG. 6A, a first PDU burst 615a may include a first PDU set 610a with PDUs 605a. 605b, 605c, and 605d as well as a second PDU set 610b with PDUs 605e and 605f. An application server 360 (or a UPF 350) may encode a TTNB field in PDU 605e of the first PDU burst 615a. The TTNB field may indicate an absolute time (e.g., a universal coordinated time (UTC)) 620a associated with a second PDU burst 615b. As further shown in FIG. 6A, the second PDU burst 615b may include a PDU set 610c with PDUs 605g. 605h, 605i, and 605j. The application server 360 (or the UPF 350) may encode a TTNB field in PDU 605g of the second PDU burst 615c. The TTNB field may indicate an absolute time (e.g., a UTC) 620b associated with a third PDU burst 615c. As further shown in FIG. 6A, the third PDU burst 615c may include a PDU set 610d with PDUs 605k, 605l, and 605m. By using the absolute time for each PDU burst, the application server 360 may eliminate error that would be introduced by jitter of an N6 interface. To further reduce error, the application server 360 may synchronize a clock with the UPF 350. Similarly, the UPF 350 may eliminate error that would be introduced by jitter of an N3 interface. To further reduce error, the UPF 350 may synchronize a clock with a RAN 100.

FIG. 6B is similar to FIG. 6A, but the TTNB field in the PDU 605e encodes a time difference 635a between a (predicted) time 630a associated with the PDU burst 615a and a (predicted) time 630b associated with the PDU burst 615b. Similarly, the TTNB field in the PDU 605g encodes a time difference 635b between the (predicted) time 630b associated with the PDU burst 615b and a (predicted) time 630c associated with the PDU burst 615c. Accordingly, the UPF 350 (or the RAN 100) may store a most recent predicted time (e.g., the time 630a or the time 630b) in order to use a time difference (e.g., the difference 635a or the difference 635b, respectively). The application server 360 and the UPF 350 (or the UPF 350 and the RAN 100) may omit clock synchronization in order to conserve resources. Instead, to reduce error, the application server 360 may transmit an indication to compensate clock drift associated with the UPF 350. Similarly, the UPF 350 may transmit an indication to compensate clock drift associated with the RAN 100.

FIG. 6C is similar to FIG. 6B, but the TTNB field in the PDU 605e encodes a time difference 645a between a transmission (or arrival) time associated with an initial PDU (the PDU 605a) of the PDU burst 615a and a (predicted) time 630a associated with the PDU burst 615b. Similarly, the TTNB field in the PDU 605g encodes a time difference 645b between a transmission (or arrival) time associated with an initial PDU (the PDU 605g) of the PDU burst 615b and a (predicted) time 630b associated with the PDU burst 615c. Accordingly, the UPF 350 (or the RAN 100) may store an arrival time (e.g., the arrival time associated with the PDU 605a or the arrival time associated with the PDU 605g) in order to use a time difference (e.g., the difference 645a or the difference 645b, respectively). The application server 360 and the UPF 350 (or the UPF 350 and the RAN 100) may omit clock synchronization in order to conserve resources. Additionally, accuracy is improved because clock drift is not accumulated across time differences.

FIG. 6D is similar to FIG. 6C, but the TTNB field in the PDU 605e encodes a time difference 665a between a transmission (or arrival) time associated with an initial PDU of a last PDU set (the PDU 605e) of the PDU burst 615a and a (predicted) time 630a associated with the PDU burst 615b. Similarly, the TTNB field in the PDU 605g encodes a time difference 665b between a transmission (or arrival) time associated with an initial PDU of a last PDU set (the PDU 605g) of the PDU burst 615b and a (predicted) time 630b associated with the PDU burst 615c. Accordingly, the UPF 350 (or the RAN 100) may store an arrival time (e.g., the arrival time associated with the PDU 605e or the arrival time associated with the PDU 605g) in order to use a time difference (e.g., the difference 665a or the difference 665b, respectively). The application server 360 and the UPF 350 (or the UPF 350 and the RAN 100) may omit clock synchronization in order to conserve resources. Additionally, accuracy is improved because clock drift is not accumulated across time differences.

FIG. 6E is similar to FIG. 6D, but the TTNB field in the PDU 605f encodes a time difference 685a between a transmission (or arrival) time associated with a PDU including the TTNB field (the PDU 605f) of the PDU burst 615a and a (predicted) time 630a associated with the PDU burst 615b. Therefore, the TTNB field in the PDU 605f encodes a time difference 685a between a transmission (or arrival) time associated with a last PDU (the PDU 605f) of the PDU burst 615a and a (predicted) time 630a associated with an initial PDU (the PDU 605g) of the PDU burst 615b. Similarly, the TTNB field in the PDU 605j encodes a time difference 685b between a transmission (or arrival) time associated with a PDU including the TTNB field (the PDU 605j) of the PDU burst 615b and a (predicted) time 630b associated with the PDU burst 615c. Therefore, the TTNB field in the PDU 605j encodes a time difference 685b between a transmission (or arrival) time associated with a last PDU (the PDU 605j) of the PDU burst 615b and a (predicted) time 630b associated with an initial PDU (the PDU 605k) of the PDU burst 615c. Accordingly, the UPF 350 (or the RAN 100) may store an arrival time (e.g., the arrival time associated with the PDU 605e or the arrival time associated with the PDU 605g) in order to use a time difference (e.g., the difference 665a or the difference 665b, respectively). The application server 360 and the UPF 350 (or the UPF 350 and the RAN 100) may omit clock synchronization in order to conserve resources. Additionally, accuracy is improved because clock drift is not accumulated across time differences.

In the examples described above that use a time difference, the TTNB field may be associated with a granularity. The granularity may be a unit of time (e.g., in microseconds or milliseconds). Alternatively, the granularity be a unit of frequency (e.g., kilohertz). In some aspects, the granularity may be defined in standard (e.g., 3GPP specifications and/or another standard). Alternatively, the granularity may be indicated in an RTP profile and/or indicated by the RAN 100 (e.g., to the UPF 350 over an AF or NEF interface). In some aspects, the UPF 350 may translate a granularity used by the application server 360 to a different granularity requested by the RAN 100.

In some aspects, the application server 360 may indicate which category of TTNB is used (e.g., in an RTP-HE). For example, the application server 360 and the UPF 350 may use SDP signaling to select four different categories of TTNB (e.g., from the five examples described above) and use two bits to indicate which of the four categories are used.

As indicated above, FIGS. 6A-6E are provided as examples. Other examples may differ from what is described with respect to FIGS. 6A-6E.

FIG. 7 is a diagram illustrating an example process 700 performed, for example, at a data source or an apparatus of a data source. Example process 700 is an example where the apparatus or the data source (e.g., application server 360 and/or UPF 350) performs operations associated with transmitting TTNB indications.

As shown in FIG. 7, in some aspects, process 700 may include encoding a TTNB field in a header of a PDU within a PDU set of a first PDU burst (block 710). For example, the data source (e.g., using communication manager 906, depicted in FIG. 9) may encode a TTNB field in a header of a PDU within a PDU set of a first PDU burst, as described herein.

As further shown in FIG. 7, in some aspects, process 700 may include transmitting, to a network element (e.g., UPF 350 and/or network 100), the PDU set of the first PDU burst (block 720). For example, the data source (e.g., using transmission component 904 and/or communication manager 906, depicted in FIG. 7) may transmit, to a network element, the PDU set of the first PDU burst, as described herein.

Process 700 may include additional aspects, such as any single aspect or any combination of aspects described below and/or in connection with one or more other processes described elsewhere herein.

In a first aspect, the data source includes an application server.

In a second aspect, alone or in combination with the first aspect, the data source includes a UPF in a core network.

In a third aspect, alone or in combination with one or more of the first and second aspects, process 700 includes transmitting (e.g., using transmission component 904 and/or communication manager 906), to the network element, a PDU set of a second PDU burst, where the TTNB field indicates a time associated with the second PDU burst.

In a fourth aspect, alone or in combination with one or more of the first through third aspects, process 700 includes encoding (e.g., using communication manager 906) an additional TTNB field in a header of a PDU within the PDU set of the second PDU burst.

In a fifth aspect, alone or in combination with one or more of the first through fourth aspects, process 700 includes refraining from encoding (e.g., using communication manager 906) an additional TTNB field within a PDU of the second PDU burst based at least in part on a value of the TTNB field being unchanged.

In a sixth aspect, alone or in combination with one or more of the first through fifth aspects, process 700 includes transmitting (e.g., using transmission component 904 and/or communication manager 906), to the network element, an additional PDU set of the first PDU burst.

In a seventh aspect, alone or in combination with one or more of the first through sixth aspects, the additional PDU set is included in the first PDU burst based at least in part on a minimum timing gap.

In an eighth aspect, alone or in combination with one or more of the first through seventh aspects, the additional PDU set is included in the first PDU burst based at least in part on the PDU set and the additional PDU set being associated with a same video frame.

In a ninth aspect, alone or in combination with one or more of the first through eighth aspects, the TTNB field indicates an absolute time associated with a subsequent PDU burst.

In a tenth aspect, alone or in combination with one or more of the first through ninth aspects, process 700 includes synchronizing (e.g., using reception component 902, transmission component 904, and/or communication manager 906, depicted in FIG. 9) a clock of the data source with a clock of the network element.

In an eleventh aspect, alone or in combination with one or more of the first through tenth aspects, the TTNB field indicates a time difference between a most recent predicted time associated with the first PDU burst and an initial PDU in a subsequent PDU burst.

In a twelfth aspect, alone or in combination with one or more of the first through eleventh aspects, process 700 includes transmitting (e.g., using transmission component 904 and/or communication manager 906) an indication to compensate drift associated with a clock of the network element.

In a thirteenth aspect, alone or in combination with one or more of the first through twelfth aspects, the TTNB field indicates a time difference between a transmission time associated with an initial PDU of the first PDU burst and a transmission time associated with an initial PDU in a subsequent PDU burst.

In a fourteenth aspect, alone or in combination with one or more of the first through thirteenth aspects, the TTNB field indicates a time difference between a transmission time associated with an initial PDU of a last PDU set in the first PDU burst and a transmission time associated with an initial PDU in a subsequent PDU burst.

In a fifteenth aspect, alone or in combination with one or more of the first through fourteenth aspects, the TTNB field indicates a time difference between a transmission time associated with a last PDU in the first PDU burst and a transmission time associated with an initial PDU in a subsequent PDU burst.

In a sixteenth aspect, alone or in combination with one or more of the first through fifteenth aspects, the PDU that includes the TTNB field further includes an end of data burst indication.

In a seventeenth aspect, alone or in combination with one or more of the first through sixteenth aspects, the TTNB field is included in an RTP-HE.

In an eighteenth aspect, alone or in combination with one or more of the first through seventeenth aspects, process 700 includes receiving (e.g., using reception component 902 and/or communication manager 906) an SDP message indicating support for the TTNB field, where the TTNB field is encoded in response to the SDP message.

In a nineteenth aspect, alone or in combination with one or more of the first through eighteenth aspects, a granularity associated with the TTNB field is a unit of time.

In a twentieth aspect, alone or in combination with one or more of the first through nineteenth aspects, a granularity associated with the TTNB field is a unit of frequency.

In a twenty-first aspect, alone or in combination with one or more of the first through twentieth aspects, a granularity associated with the TTNB field is indicated in an RTP profile.

In a twenty-second aspect, alone or in combination with one or more of the first through twenty-first aspects, process 700 includes receiving (e.g., using reception component 902 and/or communication manager 906) an indication of a granularity associated with the TTNB field.

In a twenty-third aspect, alone or in combination with one or more of the first through twenty-second aspects, the PDU that includes the TTNB field is a final PDU of the first PDU burst.

In a twenty-fourth aspect, alone or in combination with one or more of the first through twenty-third aspects, the PDU that includes the TTNB field is an initial PDU of the first PDU burst.

In a twenty-fifth aspect, alone or in combination with one or more of the first through twenty-fourth aspects, the TTNB field is included in a GTP header.

In a twenty-sixth aspect, alone or in combination with one or more of the first through twenty-fifth aspects, encoding the TTNB field includes extracting a value for the TTNB field from an RTP-HE.

In a twenty-seventh aspect, alone or in combination with one or more of the first through twenty-sixth aspects, encoding the TTNB field includes estimating a value for the TTNB field based at least in part on traffic information.

In a twenty-eighth aspect, alone or in combination with one or more of the first through twenty-seventh aspects, the header of the PDU further indicates a burst size for a next PDU burst.

In a twenty-ninth aspect, alone or in combination with one or more of the first through twenty-eighth aspects, the header of the PDU further indicates a category for the TTNB field, and the category indicates how the TTNB field indicates a time for a next PDU burst.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network element or an apparatus of a network element. Example process 800 is an example where the apparatus or the network element (e.g., UPF 350 and/or network 100) performs operations associated with receiving TTNB indications.

As shown in FIG. 8, in some aspects, process 800 may include receiving, from a data source (e.g., application server 360 and/or UPF 350), a PDU set of a first PDU burst (block 810). For example, the network element (e.g., using reception component 1002 and/or communication manager 1006, depicted in FIG. 10) may receive, from a data source, a PDU set of a first PDU burst, as described herein.

As further shown in FIG. 8, in some aspects, process 800 may include decoding a TTNB field in a header of a PDU within the PDU set of the first PDU burst (block 820). For example, the network element (e.g., using communication manager 1006) may decode a TTNB field in a header of a PDU within the PDU set of the first PDU burst, as described herein.

Process 800 may include additional aspects, such as any single aspect or any combination of aspects described below and/or in connection with one or more other processes described elsewhere herein.

In a first aspect, the network element includes a UPF in a core network.

In a second aspect, alone or in combination with the first aspect, the network element is included in a RAN.

In a third aspect, alone or in combination with one or more of the first and second aspects, process 800 includes receiving (e.g., using reception component 1002 and/or communication manager 1006), from the network element, a PDU set of a second PDU burst, where the TTNB field indicates a time associated with the second PDU burst.

In a fourth aspect, alone or in combination with one or more of the first through third aspects, process 800 includes decoding (e.g., using communication manager 1006) an additional TTNB field in a header of a PDU within the PDU set of the second PDU burst.

In a fifth aspect, alone or in combination with one or more of the first through fourth aspects, process 800 includes determining (e.g., using communication manager 1006) that a value of the TTNB field is unchanged based at least in part on a lack of an additional TTNB field within a PDU of the second PDU burst.

In a sixth aspect, alone or in combination with one or more of the first through fifth aspects, process 800 includes receiving (e.g., using reception component 1002 and/or communication manager 1006), from the network element, an additional PDU set of the first PDU burst.

In a seventh aspect, alone or in combination with one or more of the first through sixth aspects, the additional PDU set is included in the first PDU burst based at least in part on a minimum timing gap.

In an eighth aspect, alone or in combination with one or more of the first through seventh aspects, the additional PDU set is included in the first PDU burst based at least in part on the PDU set and the additional PDU set being associated with a same video frame.

In a ninth aspect, alone or in combination with one or more of the first through eighth aspects, the TTNB field indicates an absolute time associated with a subsequent PDU burst.

In a tenth aspect, alone or in combination with one or more of the first through ninth aspects, process 800 includes synchronizing (e.g., using reception component 1002, transmission component 1004, and/or communication manager 1006, depicted in FIG. 10) a clock of the data source with a clock of the data source.

In an eleventh aspect, alone or in combination with one or more of the first through tenth aspects, the TTNB field indicates a time difference between a most recent predicted time associated with the first PDU burst and an initial PDU in a subsequent PDU burst.

In a twelfth aspect, alone or in combination with one or more of the first through eleventh aspects, process 800 includes storing (e.g., using communication manager 1006) an indication of the most recent predicted time associated with the first PDU burst.

In a thirteenth aspect, alone or in combination with one or more of the first through twelfth aspects, process 800 includes receiving (e.g., using reception component 1002 and/or communication manager 1006) an indication to compensate drift associated with a clock of the network element.

In a fourteenth aspect, alone or in combination with one or more of the first through thirteenth aspects, the TTNB field indicates a time difference between an arrival time associated with an initial PDU of the first PDU burst and an arrival time associated with an initial PDU in a subsequent PDU burst.

In a fifteenth aspect, alone or in combination with one or more of the first through fourteenth aspects, process 800 includes storing (e.g., using communication manager 1006) an indication of the arrival time associated with the initial PDU of the first PDU burst.

In a sixteenth aspect, alone or in combination with one or more of the first through fifteenth aspects, the TTNB field indicates a time difference between an arrival time associated with an initial PDU of a last PDU set in the first PDU burst and an arrival time associated with an initial PDU in a subsequent PDU burst.

In a seventeenth aspect, alone or in combination with one or more of the first through sixteenth aspects, process 800 includes storing (e.g., using communication manager 1006) an indication of the arrival time associated with the initial PDU of the last PDU set of the first PDU burst.

In an eighteenth aspect, alone or in combination with one or more of the first through seventeenth aspects, the TTNB field indicates a time difference between an arrival time associated with a last PDU in the first PDU burst and an arrival time associated with an initial PDU in a subsequent PDU burst.

In a nineteenth aspect, alone or in combination with one or more of the first through eighteenth aspects, the PDU that includes the TTNB field further includes an end of data burst indication.

In a twentieth aspect, alone or in combination with one or more of the first through nineteenth aspects, the TTNB field is included in an RTP-HE.

In a twenty-first aspect, alone or in combination with one or more of the first through twentieth aspects, process 800 includes transmitting (e.g., using transmission component 1004 and/or communication manager 1006) an SDP message indicating support for the TTNB field.

In a twenty-second aspect, alone or in combination with one or more of the first through twenty-first aspects, a granularity associated with the TTNB field is a unit of time.

In a twenty-third aspect, alone or in combination with one or more of the first through twenty-second aspects, a granularity associated with the TTNB field is a unit of frequency.

In a twenty-fourth aspect, alone or in combination with one or more of the first through twenty-third aspects, a granularity associated with the TTNB field is indicated in an RTP profile.

In a twenty-fifth aspect, alone or in combination with one or more of the first through twenty-fourth aspects, process 800 includes transmitting (e.g., using transmission component 1004 and/or communication manager 1006) an indication of a granularity associated with the TTNB field.

In a twenty-sixth aspect, alone or in combination with one or more of the first through twenty-fifth aspects, the PDU that includes the TTNB field is a final PDU of the first PDU burst.

In a twenty-seventh aspect, alone or in combination with one or more of the first through twenty-sixth aspects, the PDU that includes the TTNB field is an initial PDU of the first PDU burst.

In a twenty-eighth aspect, alone or in combination with one or more of the first through twenty-seventh aspects, the TTNB field is included in a GTP header.

In a twenty-ninth aspect, alone or in combination with one or more of the first through twenty-eighth aspects, process 800 includes transmitting (e.g., using transmission component 1004 and/or communication manager 1006) the PDU set, along with information from the TTNB field, to a RAN.

In a thirtieth aspect, alone or in combination with one or more of the first through twenty-ninth aspects, process 800 includes transmitting (e.g., using transmission component 1004 and/or communication manager 1006) the PDU set, along with information from the TTNB field, to a DU.

In a thirty-first aspect, alone or in combination with one or more of the first through thirtieth aspects, process 800 includes transmitting (e.g., using transmission component 1004 and/or communication manager 1006) a configuration for a UE determined using information from the TTNB field.

In a thirty-second aspect, alone or in combination with one or more of the first through thirty-first aspects, process 800 includes transmitting (e.g., using transmission component 1004 and/or communication manager 1006) information from the TTNB field to a target node in a handover operation.

In a thirty-third aspect, alone or in combination with one or more of the first through thirty-second aspects, the header of the PDU further indicates a burst size for a next PDU burst.

In a thirty-fourth aspect, alone or in combination with one or more of the first through thirty-third aspects, the header of the PDU further indicates a category for the TTNB field, and the category indicates how the TTNB field indicates a time for a next PDU burst.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a data source (e.g., an application server or a UPF), or a data source may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 3. As shown, the apparatus 900 may communicate with another apparatus 908, such as a function in a core network (e.g., a UPF) or an element in a RAN (such as a CU, a DU, an RU, or a base station), using the reception component 902 and the transmission component 904. The communication manager 906 may be included in, or implemented via, a processing system (for example, the processing system 140 described in connection with FIG. 3) of the data source.

In some aspects, the apparatus 900 may be configured to perform one or more operations described herein in connection with FIGS. 4, 5, and/or 6A-6E. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the data source described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the data source described above in connection with FIG. 1, such as a radio, one or more RF chains, one or more transceivers, or one or more modems, each of which may in turn be coupled with one or more antennas of the data source.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the data source described above in connection with FIG. 1, such as a radio, one or more RF chains, one or more transceivers, or one or more modems, each of which may in turn be coupled with one or more antennas of the data source described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

In some aspects, the communication manager 906 may encode a TTNB field in a header of a PDU within a PDU set of a first PDU burst. Accordingly, the transmission component 904 may transmit (e.g., to the apparatus 908) the PDU set of the first PDU burst.

In some aspects, the transmission component 904 may further transmit (e.g., to the apparatus 908) a PDU set of a second PDU burst, and the TTNB field indicates a time associated with the second PDU burst. Additionally, the communication manager 906 may encode an additional TTNB field in a header of a PDU within the PDU set of the second PDU burst. Alternatively, the communication manager 906 may refrain from encoding an additional TTNB field within a PDU of the second PDU burst based at least in part on a value of the TTNB field being unchanged.

In some aspects, the transmission component 904 may transmit (e.g., to the apparatus 908) an additional PDU set of the first PDU burst.

In some aspects, the reception component 902, the transmission component 904, and/or the communication manager 906 may synchronize a clock of the apparatus 900 with a clock of the apparatus 908. Additionally, or alternatively, the transmission component 904 may transmit an indication to compensate drift associated with a clock of the apparatus 908.

In some aspects, the reception component 902 may receive (e.g., from the apparatus 908) an SDP message indicating support for the TTNB field, such that the TTNB field is encoded in response to the SDP message. Additionally, or alternatively, the reception component 902 may receive (e.g., from the apparatus 908) an indication of a granularity associated with the TTNB field.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network element (e.g., a UPF or a component in a RAN), or a network element may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 155 described in connection with FIG. 3. As shown, the apparatus 1000 may communicate with another apparatus 1008, such as an application server or a function in a core network (e.g., a UPF), using the reception component 1002 and the transmission component 1004. The communication manager 1006 may be included in, or implemented via, a processing system (for example, the processing system 145 described in connection with FIG. 3) of the network element.

In some aspects, the apparatus 1000 may be configured to perform one or more operations described herein in connection with FIGS. 4, 5, and/or 6A-6E. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the network element described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network element described above in connection with FIG. 1, such as a radio, one or more RF chains, one or more transceivers, or one or more modems, each of which may in turn be coupled with one or more antennas of the network element.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network element described above in connection with FIG. 1, such as a radio, one or more RF chains, one or more transceivers, or one or more modems, each of which may in turn be coupled with one or more antennas of the network element described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

In some aspects, the reception component 1002 may receive (e.g., from the apparatus 1008) a PDU set of a first PDU burst. Accordingly, the communication manager 1006 may decode a TTNB field in a header of a PDU within the PDU set of the first PDU burst.

In some aspects, the reception component 1002 may further receive (e.g., from the apparatus 1008) a PDU set of a second PDU burst, where the TTNB field indicates a time associated with the second PDU burst. Additionally, the communication manager 1006 may decode an additional TTNB field in a header of a PDU within the PDU set of the second PDU burst. Alternatively, communication manager 1006 may determine that a value of the TTNB field is unchanged based at least in part on a lack of an additional TTNB field within a PDU of the second PDU burst.

In some aspects, the reception component 1002 may receive (e.g., from the apparatus 1008) an additional PDU set of the first PDU burst.

In some aspects, the reception component 1002, the transmission component 1004, and/or the communication manager 1006 may synchronize a clock of the apparatus 1000 with a clock of the apparatus 1008. Additionally, or alternatively, the reception component 1002 may receive (e.g., from the apparatus 1008) an indication to compensate drift associated with a clock of the apparatus 1000.

In some aspects, the communication manager 1006 may store an indication of a most recent predicted time associated with the first PDU burst. Additionally, or alternatively, the communication manager 1006 may store an indication of the arrival time associated with an initial PDU of the first PDU burst. Additionally, or alternatively, the communication manager 1006 may store an indication of the arrival time associated with an initial PDU of a last PDU set of the first PDU burst.

In some aspects, the transmission component 1004 may transmit (e.g., to the apparatus 1008) an SDP message indicating support for the TTNB field. Additionally, or alternatively, the transmission component 1004 may transmit (e.g., to the apparatus 1008) an indication of a granularity associated with the TTNB field.

In some aspects, the transmission component 1004 may transmit the PDU set, along with information from the TTNB field, to a RAN. Alternatively, the transmission component 1004 may transmit the PDU set, along with information from the TTNB field, to a DU. In some aspects, the transmission component 1004 may transmit a configuration for a UE determined using information from the TTNB field. Additionally, or alternatively, the transmission component 1004 may transmit information from the TTNB field to a target node in a handover operation.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a data source, comprising: encoding a time to next burst (TTNB) field in a header of a protocol data unit (PDU) within a PDU set of a first PDU burst; and transmitting, to a network element, the PDU set of the first PDU burst.
Aspect 2: The method of Aspect 1, wherein the data source comprises an application server.
Aspect 3: The method of Aspect 1, wherein the data source comprises a user plane function in a core network.
Aspect 4: The method of any of Aspects 1-3, further comprising: transmitting, to the network element, a PDU set of a second PDU burst, wherein the TTNB field indicates a time associated with the second PDU burst.
Aspect 5: The method of Aspect 4, further comprising: encoding an additional TTNB field in a header of a PDU within the PDU set of the second PDU burst.
Aspect 6: The method of Aspect 4, further comprising: refraining from encoding an additional TTNB field within a PDU of the second PDU burst based at least in part on a value of the TTNB field being unchanged.
Aspect 7: The method of any of Aspects 1-6, further comprising: transmitting, to the network element, an additional PDU set of the first PDU burst.
Aspect 8: The method of Aspect 7, wherein the additional PDU set is included in the first PDU burst based at least in part on a minimum timing gap.
Aspect 9: The method of any of Aspects 6-7, wherein the additional PDU set is included in the first PDU burst based at least in part on the PDU set and the additional PDU set being associated with a same video frame.
Aspect 10: The method of any of Aspects 1-9, wherein the TTNB field indicates an absolute time associated with a subsequent PDU burst.
Aspect 11: The method of any of Aspects 1-10, further comprising: synchronizing a clock of the data source with a clock of the network element.
Aspect 12: The method of any of Aspects 1-11, wherein the TTNB field indicates a time difference between a most recent predicted time associated with the first PDU burst and an initial PDU in a subsequent PDU burst.
Aspect 13: The method of any of Aspects 1-12, further comprising: transmitting an indication to compensate drift associated with a clock of the network element.
Aspect 14: The method of any of Aspects 1-13, wherein the TTNB field indicates a time difference between a transmission time associated with an initial PDU of the first PDU burst and a transmission time associated with an initial PDU in a subsequent PDU burst.
Aspect 15: The method of any of Aspects 1-14, wherein the TTNB field indicates a time difference between a transmission time associated with an initial PDU of a last PDU set in the first PDU burst and a transmission time associated with an initial PDU in a subsequent PDU burst.
Aspect 16: The method of any of Aspects 1-15, wherein the TTNB field indicates a time difference between a transmission time associated with a last PDU in the first PDU burst and a transmission time associated with an initial PDU in a subsequent PDU burst.
Aspect 17: The method of any of Aspects 1-16, wherein the PDU that includes the TTNB field further includes an end of data burst indication.
Aspect 18: The method of any of Aspects 1-17, wherein the TTNB field is included in a real time protocol header extension (RTP-HE).
Aspect 19: The method of any of Aspects 1-18, further comprising: receiving a session description protocol (SDP) message indicating support for the TTNB field, wherein the TTNB field is encoded in response to the SDP message.
Aspect 20: The method of any of Aspects 1-19, wherein a granularity associated with the TTNB field is a unit of time.
Aspect 21: The method of any of Aspects 1-19, wherein a granularity associated with the TTNB field is a unit of frequency.
Aspect 22: The method of any of Aspects 1-21, wherein a granularity associated with the TTNB field is indicated in a real time protocol (RTP) profile.
Aspect 23: The method of any of Aspects 1-22, further comprising: receiving an indication of a granularity associated with the TTNB field.
Aspect 24: The method of any of Aspects 1-23, wherein the PDU that includes the TTNB field is a final PDU of the first PDU burst.
Aspect 25: The method of any of Aspects 1-23, wherein the PDU that includes the TTNB field is an initial PDU of the first PDU burst.
Aspect 26: The method of any of Aspects 1-25, wherein the TTNB field is included in a general packet radio service (GPRS) tunnelling protocol (GTP) header.
Aspect 27: The method of any of Aspects 1-26, wherein encoding the TTNB field comprises: extracting a value for the TTNB field from a real time protocol header extension (RTP-HE).
Aspect 28: The method of any of Aspects 1-27, wherein encoding the TTNB field comprises: estimating a value for the TTNB field based at least in part on traffic information.
Aspect 29: The method of any of Aspects 1-28, wherein the header of the PDU further indicates a burst size for a next PDU burst.
Aspect 30: The method of any of Aspects 1-29, wherein the header of the PDU further indicates a category for the TTNB field, and the category indicates how the TTNB field indicates a time for a next PDU burst.
Aspect 31: A method of wireless communication performed by a network element, comprising: receiving, from a data source, a protocol data unit (PDU) set of a first PDU burst; and decoding a time to next burst (TTNB) field in a header of a PDU within the PDU set of the first PDU burst.
Aspect 32: The method of Aspect 31, wherein the network element comprises a user plane function in a core network.
Aspect 33: The method of Aspect 31, wherein the network element is included in a radio access network.
Aspect 34: The method of any of Aspects 31-33, further comprising: receiving, from the network element, a PDU set of a second PDU burst, wherein the TTNB field indicates a time associated with the second PDU burst.
Aspect 35: The method of Aspect 34, further comprising: decoding an additional TTNB field in a header of a PDU within the PDU set of the second PDU burst.
Aspect 36: The method of Aspect 34, further comprising: determining that a value of the TTNB field is unchanged based at least in part on a lack of an additional TTNB field within a PDU of the second PDU burst.
Aspect 37: The method of any of Aspects 31-36, further comprising: receiving, from the network element, an additional PDU set of the first PDU burst.
Aspect 38: The method of Aspect 37, wherein the additional PDU set is included in the first PDU burst based at least in part on a minimum timing gap.
Aspect 39: The method of any of Aspects 37-38, wherein the additional PDU set is included in the first PDU burst based at least in part on the PDU set and the additional PDU set being associated with a same video frame.
Aspect 40: The method of any of Aspects 31-39, wherein the TTNB field indicates an absolute time associated with a subsequent PDU burst.
Aspect 41: The method of any of Aspects 31-40, further comprising: synchronizing a clock of the data source with a clock of the data source.
Aspect 42: The method of any of Aspects 31-41, wherein the TTNB field indicates a time difference between a most recent predicted time associated with the first PDU burst and an initial PDU in a subsequent PDU burst.
Aspect 43: The method of Aspect 42, further comprising: storing an indication of the most recent predicted time associated with the first PDU burst.
Aspect 44: The method of any of Aspects 31-43, further comprising: receiving an indication to compensate drift associated with a clock of the network element.
Aspect 45: The method of any of Aspects 31-44, wherein the TTNB field indicates a time difference between an arrival time associated with an initial PDU of the first PDU burst and an arrival time associated with an initial PDU in a subsequent PDU burst.
Aspect 46: The method of Aspect 45, further comprising: storing an indication of the arrival time associated with the initial PDU of the first PDU burst.
Aspect 47: The method of any of Aspects 31-46, wherein the TTNB field indicates a time difference between an arrival time associated with an initial PDU of a last PDU set in the first PDU burst and an arrival time associated with an initial PDU in a subsequent PDU burst.
Aspect 48: The method of Aspect 47, further comprising: storing an indication of the arrival time associated with the initial PDU of the last PDU set of the first PDU burst.
Aspect 49: The method of any of Aspects 31-48, wherein the TTNB field indicates a time difference between an arrival time associated with a last PDU in the first PDU burst and an arrival time associated with an initial PDU in a subsequent PDU burst.
Aspect 50: The method of any of Aspects 31-49, wherein the PDU that includes the TTNB field further includes an end of data burst indication.
Aspect 51: The method of any of Aspects 31-50, wherein the TTNB field is included in a real time protocol header extension (RTP-HE).
Aspect 52: The method of any of Aspects 31-51, further comprising: transmitting a session description protocol (SDP) message indicating support for the TTNB field.
Aspect 53: The method of any of Aspects 31-52, wherein a granularity associated with the TTNB field is a unit of time.
Aspect 54: The method of any of Aspects 31-52, wherein a granularity associated with the TTNB field is a unit of frequency.
Aspect 55: The method of any of Aspects 31-54, wherein a granularity associated with the TTNB field is indicated in a real time protocol (RTP) profile.
Aspect 56: The method of any of Aspects 31-55, further comprising: transmitting an indication of a granularity associated with the TTNB field.
Aspect 57: The method of any of Aspects 31-56, wherein the PDU that includes the TTNB field is a final PDU of the first PDU burst.
Aspect 58: The method of any of Aspects 31-56, wherein the PDU that includes the TTNB field is an initial PDU of the first PDU burst.
Aspect 59: The method of any of Aspects 31-58, wherein the TTNB field is included in a general packet radio service (GPRS) tunnelling protocol (GTP) header.
Aspect 60: The method of any of Aspects 31-59, further comprising: transmitting the PDU set, along with information from the TTNB field, to a radio access network.
Aspect 61: The method of any of Aspects 31-60, further comprising: transmitting the PDU set, along with information from the TTNB field, to a distributed unit.
Aspect 62: The method of any of Aspects 31-60, further comprising: transmitting a configuration for a user equipment (UE) determined using information from the TTNB field.
Aspect 63: The method of any of Aspects 31-60, further comprising: transmitting information from the TTNB field to a target node in a handover operation.
Aspect 64: The method of any of Aspects 31-63, wherein the header of the PDU further indicates a burst size for a next PDU burst.
Aspect 65: The method of any of Aspects 31-64, wherein the header of the PDU further indicates a category for the TTNB field, and the category indicates how the TTNB field indicates a time for a next PDU burst.
Aspect 66: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-65.
Aspect 67: An apparatus for wireless communication at a device, the apparatus comprising one or more memories and one or more processors coupled to the one or more memories, the one or more processors configured to cause the device to perform the method of one or more of Aspects 1-65.
Aspect 68: An apparatus for wireless communication, the apparatus comprising at least one means for performing the method of one or more of Aspects 1-65.
Aspect 69: A non-transitory computer-readable medium storing code for wireless communication, the code comprising instructions executable by one or more processors to perform the method of one or more of Aspects 1-65.
Aspect 70: A non-transitory computer-readable medium storing a set of instructions for wireless communication, the set of instructions comprising one or more instructions that, when executed by one or more processors of a device, cause the device to perform the method of one or more of Aspects 1-65.
Aspect 71: A device for wireless communication, the device comprising a processing system that includes one or more processors and one or more memories coupled with the one or more processors, the processing system configured to cause the device to perform the method of one or more of Aspects 1-65.
Aspect 72: An apparatus for wireless communication at a device, the apparatus comprising one or more memories and one or more processors coupled to the one or more memories, the one or more processors individually or collectively configured to cause the device to perform the method of one or more of Aspects 1-65.
Aspect 73: A device comprising a processing system that includes one or more processors and one or more code-storing memories coupled with the one or more processors, the processing system configured to cause the device to perform the method of one or more of Aspects 1-65.
Aspect 74: A device comprising a processing system that includes processor circuitry and code-storing memory circuitry, the processing system configured to cause the device to perform the method of one or more of Aspects 1-65.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having.” “comprise.” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A data source, comprising:
a processing system that includes one or more processors and one or more code-storing memories coupled with the one or more processors, the processing system configured to cause the data source to:
encode a time to next burst (TTNB) field in a header of a protocol data unit (PDU) within a PDU set of a first PDU burst; and
transmit, to a network element, the PDU set of the first PDU burst.

2. The data source of claim 1, wherein the data source comprises a user plane function in a core network.

3. The data source of claim 1, wherein the processing system is configured to cause the data source to:
transmit, to the network element, an additional PDU set of the first PDU burst.

4. The data source of claim 3, wherein the additional PDU set is included in the first PDU burst based at least in part on a minimum timing gap or based at least in part on the PDU set and the additional PDU set being associated with a same video frame.

5. The data source of claim 1, wherein the TTNB field indicates a time difference between a transmission time associated with a last PDU in the first PDU burst and a transmission time associated with an initial PDU in a subsequent PDU burst.

6. The data source of claim 1, wherein the TTNB field is included in a real time protocol header extension (RTP-HE).

7. The data source of claim 1, wherein the processing system is configured to cause the data source to:
receive a session description protocol (SDP) message indicating support for the TTNB field,
wherein the TTNB field is encoded in response to the SDP message.

8. The data source of claim 1, wherein a granularity associated with the TTNB field is a unit of time.

9. The data source of claim 1, wherein the TTNB field is included in a general packet radio service (GPRS) tunnelling protocol (GTP) header.

10. The data source of claim 1, wherein, to encode the TTNB field, the processing system is configured to cause the data source to:
extract a value for the TTNB field from a real time protocol header extension (RTP-HE).

11. A network element, comprising:
a processing system that includes one or more processors and one or more code-storing memories coupled with the one or more processors, the processing system configured to cause the network element to:
receive, from a data source, a protocol data unit (PDU) set of a first PDU burst; and
decode a time to next burst (TTNB) field in a header of a PDU within the PDU set of the first PDU burst.

12. The network element of claim 11, wherein the network element comprises a user plane function in a core network.

13. The network element of claim 11, wherein the network element is included in a radio access network.

14. The network element of claim 11, wherein the TTNB field indicates a time difference between an arrival time associated with a last PDU in the first PDU burst and an arrival time associated with an initial PDU in a subsequent PDU burst.

15. The network element of claim 11, wherein the TTNB field is included in a real time protocol header extension (RTP-HE).

16. The network element of claim 11, wherein the processing system is configured to cause the network element to:
transmit a session description protocol (SDP) message indicating support for the TTNB field.

17. The network element of claim 11, wherein a granularity associated with the TTNB field is a unit of time.

18. The network element of claim 11, wherein the TTNB field is included in a general packet radio service (GPRS) tunnelling protocol (GTP) header.

19. The network element of claim 11, wherein the processing system is configured to cause the network element to:
transmit the PDU set, along with information from the TTNB field, to a radio access network.

20. A method for communication performed by a data source, comprising:
encoding a time to next burst (TTNB) field in a header of a protocol data unit (PDU) within a PDU set of a first PDU burst; and
transmitting, to a network element, the PDU set of the first PDU burst.
